(19) United States
(12) Patent Application Publication
(10) Pub. No.: US 2008/0149413 A1
(43) Pub. Date: Jun. 26, 2008

(54) Electromechanical Power Assisted Steering System

(75) Inventors: Alexander Kiforiuk, Ebersbach An Der Fils (DE); Christian Staudenmann, Mamishaus (CH); Joseph-Leon Strobel, Liechtenstein (CH)

Correspondence Address: CONNOLLY BOVE LODGE & HUTZ, LLP, P O BOX 2207, WILMINGTON, DE, 19899, US

(73) Assignee: ThyssenKrupp Presta AG, Eschen (LI)

(21) Appl. No.: 11/910,386

(22) PCT Filed: Mar. 29, 2006
(86) PCT No.: PCT/EP06/02843

§ 371 Date: Mar. 7, 2008

(30) Foreign Application Priority Data
Apr. 4, 2005 (DE) 10-2005-015-451.4

(51) Int. Cl. B62D 5/04; F16H 55/24

(52) U.S. Cl. 180/444

(57) ABSTRACT

A power-assisted steering system is disclosed. A motor is coupled by a motor shaft and a clutch to a worm shaft, which in turn engages a worm wheel. The worm shaft and the worm wheel are mounted in the gearbox housing. The distal end of the worm shaft is mounted in a bearing, and a proximal end of the worm shaft is mounted to the clutch. This construction permits inclusion of a partial housing coupled to the gearbox and enclosing the motor. Both ends of the motor shaft may be mounted in the partial housing motor bearings, and the partial housing may be displaceable with respect to the gearbox housing. Further, the motor may be locationally adjustable with the partial housing in a radial direction defined by an axis of rotation of the motor shaft.

### PRIORITY

Priority is claimed as a national stage application, under 35 U.S.C. § 371, to PCT/EP2006/002843, filed Mar. 29, 2006, which claims priority to German application 10 2005 015 451.4, filed Apr. 4, 2005.

The present invention relates to a power assisted steering system with a motor with the features of the preamble to Claim 1.

In the meaning of the invention, power assisted steering systems, especially also electromechanical power assisted steering systems, in which there is an operational mechanical coupling between the steering wheel and the pivot arrangement of the wheels, and steer-by-wire steering systems, in which there is no mechanical coupling between the steering wheel and the pivot arrangement of the wheels, are encompassed by the term steering system. This also applies to what are referred to as overlap steering systems.

Steer-by-wire and electromechanical power assisted steering systems are known from practice in a number of different design forms. In general, an electric motor is mounted in a gear housing. Its drive shaft is connected to a coaxial worm shaft either as one piece or via a coupling. The worm shaft engages with a worm wheel, which is used to drive the steering itself. The term “drive” in this context is understood to mean the imposition of torque for the driving of the steering or an ancillary torque for the reduction of the manual power which the driver is required to apply to the steering wheel. A control unit regulates the value of the imposed torque by means of a torque sensor and, as appropriate, other input data. The torque can in this context be applied into the steering column or onto a steering pinion engaging with the toothed bar.

There are operational circumstances in which the electric motor must only produce low torque values or no power-assist support, such as with fast straight-ahead driving, in which the steering oscillates around the middle position with low forces and torque values. In these operational states, the electric motor, which is necessarily coupled to the steering system via the transmission, is actuated with rapid alternating movements with low amplitude.

If the engagement between the worm shaft and the worm wheel has a degree of play, in the operational state last described, as well as in any change of direction of load, noises are incurred on engagement. There are accordingly numerous proposals for bringing the two transmission elements into engagement with preliminary tension. All the proposals have in common the fact that the worm shaft is mounted on bearings at both ends, that the preliminary tension of the worm shaft in the direction towards the worm wheel is effected by a preliminary tension of the bearing of the worm shaft which is at a distance from the motor and that provision is made for the avoidance of the angle offset incurred as a result of the axis of rotation of the worm shaft.

From DE 102 018 66 A1, for example, a power assisted steering system of this kind is known, in which the worm shaft is mounted in a ball bearing in the bearing seat close to the motor, while the bearing which is at a distance from the motor is a needle bearing, which is under preliminary tension from a helical spring in the direction of the worm wheel. The preliminary tension of the bearing at a distance from the motor and the movement of the worm shaft in the radial direction which this makes possible causes a possible restriction of the axes of rotation of the motor, on the one hand, and of the worm shaft on the other hand. This restriction is absorbed in an elastic coupling which is provided by two concentric coupling elements with an elastic body made of rubber or the like arranged between them.

The closest prior art is described in EP 1 087 883 B1. In this specification, a drive system for an electromechanical power assisted steering system is likewise represented, in which an electric motor drives a coaxial worm shaft. The worm shaft is mounted on both sides in ball bearings. The worm shaft bearing at a distance from the motor is subjected to preliminary tension in the direction of the worm wheel by a leaf spring. The armature of the motor is mounted in a ball bearing on the side turned away from the worm shaft. The end of the motor shaft adjacent to the worm shaft is connected to the worm shaft by means of an elastic coupling, which is arranged in the manner of a jaw clutch with an elastomer element lying between the jaws. The jaw clutch allows for a restriction of the two axes of rotation in relation to one another. The possible offset of the axes to one another in the radial direction in the area of the coupling is restricted by the design of the clutch.

The two technical solutions in the documents referred to have the fact in common that the springing arrangement and adjustment of the worm shaft is carried out at the bearing at a distance from the motor and that the coupling between the motor and the worm shaft occurs via a separate and elastic coupling, the object of which is to compensate for the angle offset between the worm shaft and the motor shaft. These solutions are elaborate.

The object of the present invention is, therefore, to provide a steering system with a motor, in which the freedom of play of the engagement between the worm shaft and the motor-driven worm wheel is guaranteed in a simpler manner.

This object is resolved by a steering system with the features of claim 1. In this case, it is even immaterial whether the motor is designed as an electric motor or as a hydraulic or pneumatic motor.

The object is resolved by a steering system with a motor, wherein the steering system is designed as a power assisted steering system and the motor as a servomotor, or the steering system as a steer-by-wire steering system and the motor as a drive motor, and the motor is connected by means of a motor shaft and a flexible clutch in drive fashion to a worm shaft, in which the worm shaft engages with a worm wheel and in which the motor, the worm shaft and the worm wheel are mounted in a gearbox housing and the motor shaft and the worm shaft in each case define an axis of rotation, wherein, according to the invention:
the motor shaft is mounted, in each case with a motor bearing in the vicinity of the coupling and a motor bearing at a distance from the coupling, in a partial housing which can be displaced in relation to the gearbox housing,
the motor is locationally adjustable with the partial housing in the radial direction of its axis of rotation,
the worm shaft is mounted at its end at a distance from the coupling in a bearing and at its end in the vicinity of the coupling in the coupling.

Because the motor shaft is mounted, in each case with a motor bearing in the vicinity of the coupling and a motor bearing at a distance from the coupling, in a partial housing which can be displaced in relation to the gearbox housing, the motor with the partial housing is locationally adjustable at least in the radial direction to its axis of rotation and the worm shaft is mounted at its end at a distance from the coupling in a bearing and at its end in the vicinity of the coupling in the coupling, an adjustment of the worm shaft to the engagement with the worm wheel can be carried out in such a manner that the radial forces incurred and the change of geometry of the axes of rotation of the motor and the change of geometry of the worm shaft are absorbed in the coupling alone. In particular, the coupling is designed in such a way that it compensates for the angle offset and/or the axis offset between the worm shaft and the motor shaft and simultaneously applies a resultant force onto the worm shaft in the direction of the worm wheel. In this situation, the force can be applied by elastic elements and/or by the rotational movement of the motor shaft.

A simple adjustment possibility for the engagement, which can be set at the works, can be provided so that the partial housing is mounted at the gearbox housing in a rotatable seat, eccentric in relation to the motor shaft.

In this situation, it is sufficient if the partial housing at the gearbox housing has an adjustment range in the radial direction of less than 1 mm. The eccentric seat can be designed as a sleeve, which, on the one hand, is mounted in the partial housing and, on the other hand, is rotatably mounted in the gearbox housing.

The flexible coupling can be a torsionally stiff coupling, for example of the type of a cross-slit coupling (Oldham coupling). Tolerances in the circular run of the worm wheel can be absorbed by an elastic flexible clutch, the elastic element of which allows for a spring damping effect of the worm shaft onto the worm wheel.

If the coupling is a jaw clutch with a pressure-elastic elastomer located between the jaws, a largely torsionally stiff connection with only relative rotation angles is guaranteed, so that the connection of motor shaft—worm shaft—worm wheel will remain in the reversal of the direction of rotation without disadvantageous phase differences

The motor bearings can be designed in a tried and trusted manner as radial deep-groove ball bearings. It is then possible to do without elaborate bearings with spring damping elements.

An embodiment of the present invention is described hereafter on the basis of diagrammatic drawings. These show:

FIG. 1 A power assisted steering system according to the invention, in a side view in the direction of the axis of rotation of the worm wheel;

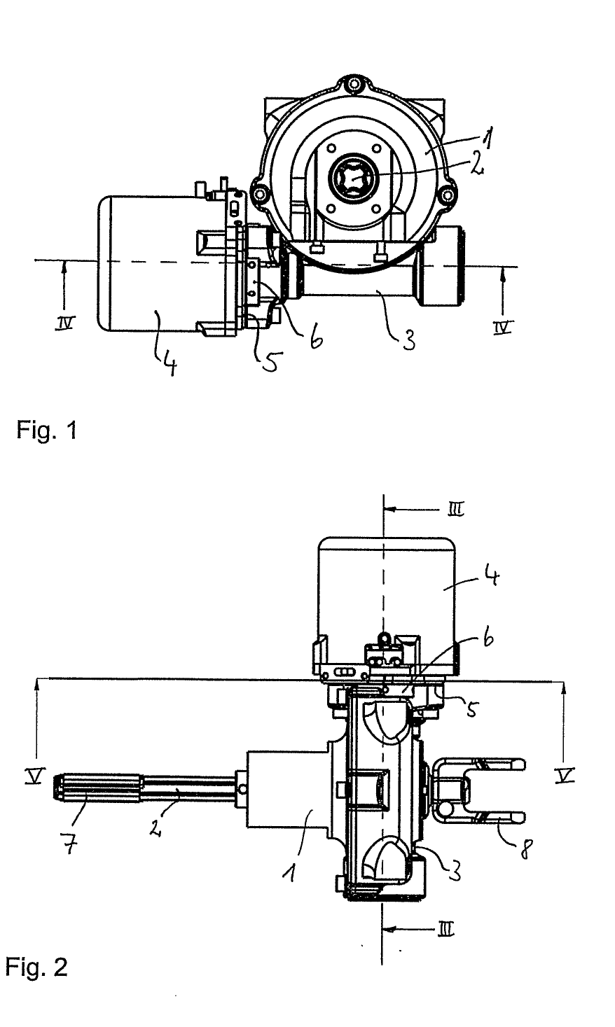

FIG. 2 The power assisted steering system from FIG. 1 in a side view rotated through 90°;

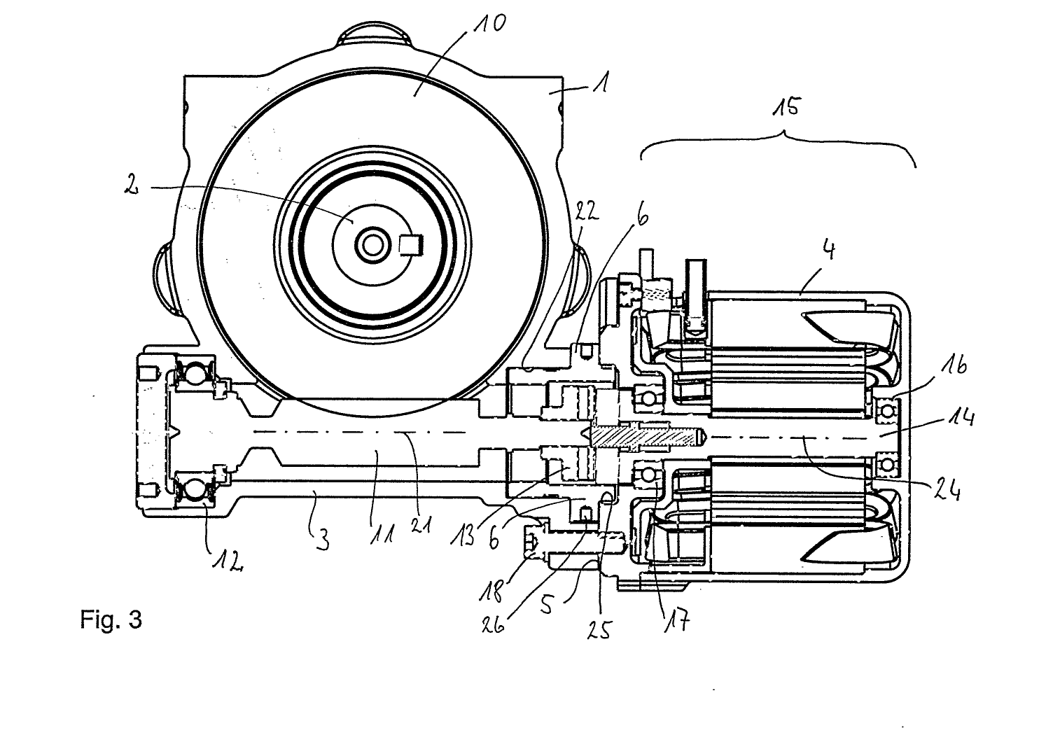

FIG. 3 The power assisted steering system in a view according to FIG. 1 in a cross-section along the axis of rotation of the electric motor;

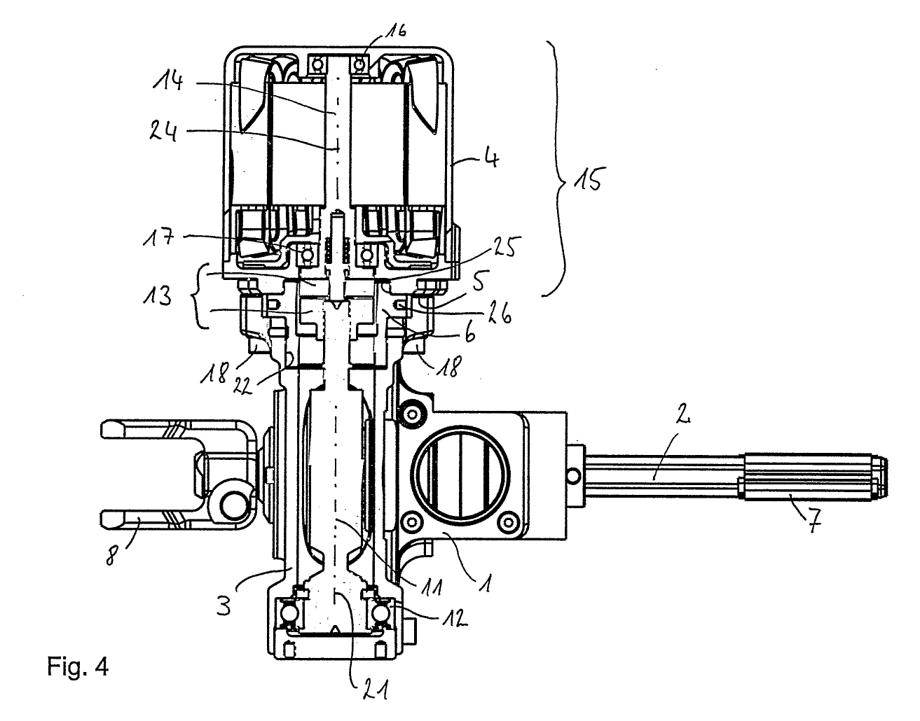

FIG. 4 The power assisted steering system in a view according to FIG. 2 in a cross-section along the axis of rotation of the electric motor;

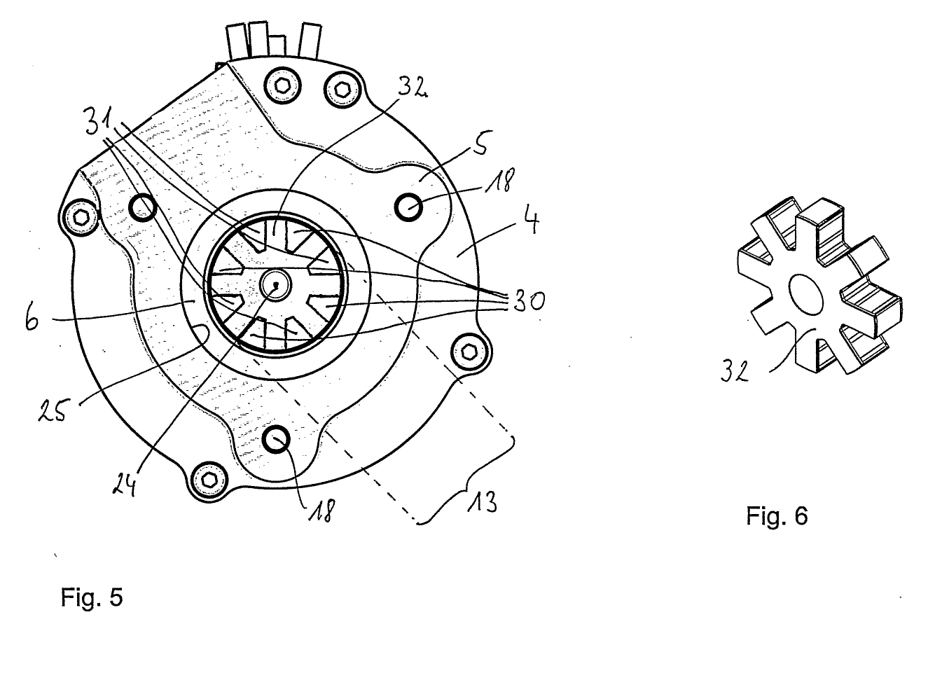

FIG. 5 The power assisted steering system in a section along the line V-V from FIG. 2; and

FIG. 6 An elastic coupling element for connecting the motor shaft and the worm shaft in a perspective representation.

FIG. 1 shows a power assisted steering system in a side view. This is an embodiment as an electromechanical power assisted steering system, in which the steering column is driven by the servo motor. This type of design is called a column drive. Specifically, FIG. 1 shows the transmission of the power assisted steering system with a gearbox housing 1, in which a steering column 2 is rotatably mounted. Mounted in the gearbox housing 1 is a worm wheel, which is coaxially connected in a torsionally-resistant manner to the steering column 2. The worm wheel engages with a worm shaft arranged in a housing area 3.

This shaft in turn is in connection in drive fashion with an electric servomotor, which is arranged in a partial housing 4. The partial housing 4 is arranged in an adjustable manner opposite the housing area 3 in the radial direction of the worm shaft. For this purpose, a flange 5 is provided, in which an eccentric sleeve 6 allows connection and adjustment of the partial housing 4 in relation to the housing area 3.

FIG. 2 shows the power assisted steering system according to FIG. 1 in a side view rotated through 90°. The same structural elements bear the same reference numbers. In this view, the steering column 2 is visible in its side view. This is a section of the steering column as a whole, which, on the one hand, is provided with a multi-toothed element 7 for torsionally-resistant connection to a steering wheel and, on the other hand, with a fork 8 for Cardan connection to the input shaft of an inherently known steering gear, e.g. of the toothed bar steering type.

In FIG. 3 the power assisted steering system from FIGS. 1 and 2 is represented in a cross-section along the line III-III from FIG. 2. In a way known per se, a worm wheel 10 is connected to the steering column 2 in a torsionally-resistant manner and is indirectly mounted in the housing 1 by means of the steering column. The worm wheel 10 engages with a worm shaft 11, which is mounted at its free end in a radial deep-groove ball bearing 12. At its end located opposite the ball bearing 12, the steering shaft 11 is coupled in drive fashion by means of a coupling 13 to a motor shaft 14 of a servomotor, designated overall by 15. The motor shaft 14 is mounted in a ball bearing 16 located at a distance from the coupling, and in a ball bearing 17 in the vicinity of the coupling, in the partial housing 4.

Threaded screws 18 secure the partial housing 4 to the gearbox housing 3 in the area of the flange 5. Parallel to the plane of the flange 5, in other words, radial to the motor shaft 14, the partial housing 4 can be adjusted to a slight degree in relation to the gearbox housing 3. For this purpose, the eccentric sleeve 6 is mounted, on the one hand, eccentrically to an axis of rotation 21 of the worm shaft 11 in a hole 22 in the gearbox housing 3. On the other hand, the eccentric sleeve 6 is mounted concentrically to the motor shaft 14, which defines a second axis of rotation 24, in a corresponding hole 25 of the partial housing 4. The eccentric sleeve 6 has a plurality of blind holes 26, which can be engaged with a pin spanner or hook spanner wrench in order to rotate the eccentric sleeve 6.

In an alternative embodiment, instead of the blind holes 26, a hexagonal headed wrench or another form of engagement of a tool, such as a screwdriver, can be provided at the outer circumference.

FIG. 4 shows the power assisted steering system described thus far in a cross-section along the line IV-IV from FIG. 1. In this direction of consideration, the engagement is located between the worm shaft 11 and the worm wheel 10 beneath the worm shaft 11, covered by the worm shaft 11, and is not visible in FIG. 4. In order to set the worm shaft 11 onto the worm wheel 10, the worm shaft 11 must be displaced in the area of the engagement perpendicular to the plane of the drawing. The alignment of the two axes of rotation 21 and 24 is not changed as a result.

FIG. 5 shows a further cross-section through the power assisted steering system along the line V-V from FIG. 2. The section runs through the flange 5, which in this representation coincides with the planes of the drawing.

FIG. 5 shows how the eccentric sleeve 6 is inserted into the hole 25, and that the coupling 13 and the motor shaft coaxial to the coupling are located concentrically to the eccentric sleeve 6. The coupling 13 is essentially of three parts. The first part is an arrangement of four claws 30, which are arranged at an angle spacing of 90° in each case about the axis of rotation 24 of the motor shaft. The second part is formed likewise from four claws 31, which are connected to the worm shaft 11 and are likewise arranged at an angle spacing of 90° about the axis of rotation 21 of the worm shaft 11. The third element of the jaw coupling is a star-shaped elastic coupling element 32, which fills the intermediate space between the claws 30 and 31.

The elastic coupling element 32 is represented in perspective in FIG. 6. The elastic coupling element is preferably formed by an elastomer. It is also possible, however, for plastic or spring-inducing metal elements to be used.

The means of functioning of the power assisted steering system described is described on the basis of FIG. 3. In this Figure, the engagement of the worm wheel 10 and the worm shaft 11 is represented as overlapping of the two component elements. The two component elements form a worm wheel gear system. As in the prior art, such a gear system should be free of play, in order not to produce any noise in the event of a load change. For this purpose, the worm shaft 11 can be displaced in the direction of the worm wheel 10, and, specifically in this embodiment, both adjustably as well as with elastic springing.

The coupling 13 between the motor shaft 14 and the worm shaft 11 is basically of the flexible clutch type, and in this special case of the elastic jaw clutch type, which is capable of compensating for an angle difference between the two axes of rotation 21 and 24, an axial offset, and, as appropriate, also an axial play. The worm shaft 11 is mounted so as to be floating in the coupling 13.

In order to attain a permanently play-free gear system, the assembly is carried out in such a way that, initially, the steering column 2, the worm wheel 10, and the worm shaft 11 with the bearings associated with them are mounted in the gearbox housing 3. The eccentric sleeve 6 is inserted into the eccentric hole 22. The servomotor 15 with its partial housing 4 is then mounted. The motor-side claw 30 is connected in a torsionally-resistant manner to the motor shaft 14 or is formed as one piece on this motor shaft. The claw 31 allocated to the worm shaft 11 is secured on the worm shaft. The elastic coupling element, preferably the elastomer 32, is then placed onto one of the two claws and the partial housing 4 is placed onto the gearbox housing 3 in the area of the flange 5 in such a way that the eccentric sleeve 6 can be introduced into the hole 25 of the partial housing 4, aligned concentrically to the motor shaft 14, and that the other claw of the coupling 33 in each case engages into the remaining intermediate spaces of the elastomer 32. The three threaded screws 18 can then initially be screwed into the partial housing 4 sufficiently far that the motor in the flange 5 is just still capable of displacement opposite the gearbox housing 3. In order to make this possible, the passage holes of the gearbox housing 3 through which the threaded screws 18 pass are correspondingly increased in diameter or formed as longitudinal holes.

A rotation of the eccentric sleeve 6 now incurs a parallel displacement of the axis of rotation 24 of the motor shaft 14, and in this situation the coupling 13 carries the floating mounted end of the worm shaft 11 with it. The worm shaft 11 is, on the other hand, mounted securely in the gearbox housing 3, in the radial ball bearing 12, so that the inclination of the axis of rotation 21 of the worm shaft 11 changes.

For adjustment of the gear system, the electric motor 15 is now subjected to current and so causes the motor shaft to rotate. Via the coupling 13, this takes the worm shaft 11 with it, and, by engagement of the tooth arrangement of the worm wheel 10, rotates. With a hook spanner, which engages into the holes 26 of the eccentric sleeve 6, this is rotated in the holes 22 and 25. The worm shaft 11, as a result, and depending on the position of the eccentric sleeve 6, is brought closer to the worm wheel 10 or taken further away from the worm wheel 10. A measurement of the current consumption of the electric motor 15 or an alternative measurement of the drive torque of the worm shaft 11 with this method gives an indication of the friction incurred in the gear system. An optimum setting of the engagement by means of the eccentric sleeve 6 is located, depending on the specific design of the gear system, approximately in the range in which the friction begins to rise, which can be identified by increasing current consumption of the electric motor 15. Gear systems of this type are not necessarily symmetrical with respect to the direction of rotation. Accordingly, it is preferred for the adjustment of the engagement between the worm shaft 11 and the worm wheel 10 to be carried out in such a way that both directions of rotation of the electric motor 15 are taken into account. For this purpose, the direction of rotation is intermittently reversed and for both directions of rotation a compromise is sought between the two possible non-concordant optimum settings of the eccentric sleeve 6.

The setting range which is made possible by the eccentricity of the eccentric sleeve 6, in other words the range in which the partial housing 4 can be moved in relation to the gearbox housing 3 in the plane of the flange 5, can be selected within the framework of the greatest manufacturing tolerance to be anticipated for the worm shaft 11 and the worm wheel 10. A usable adjustment range of about +/−0.1 mm should be sufficient in practice. Under the circumstances represented in FIG. 3, this corresponds to an angle change of the axis of rotation 21, in relation to the axis of rotation 24, displaced parallel and unchanged in angle, of less than 0.1°.

Such angle deviations are in practical terms to be permanently overcome by all flexible clutches.

Accordingly, for the coupling 13, non-elastic torsionally-stiff clutches, such as what is known as the Oldham clutch, come into consideration. An advantageous factor with the embodiment shown, with an elastic jaw clutch, however, is that not only is an adjustment of the position of the worm shaft 11 possible in relation to the worm wheel 10, but that the elastic flexible clutch 13 also tolerates a slight axial offset, which is absorbed in the elastomer 32 and which can be used for spring damping of the worm shaft 11 in the direction of the worm wheel 10. The choice of the coupling 13 may also change depending on the application situation. Thus, for example, the torque to be transferred and the maximum anticipated revolution speed of the motor shaft 14 are to be taken into account.

It is to be expected that the adjustment setting, once found, will guarantee the power assisted steering system the required freedom of play over its anticipated service life. In particular, the elastomer 32 will not develop any “setting”, since it is not statically loaded in one direction, but the load direction constantly rotates in operation. If, in the course of time, the development of noise leads to the suspicion that there is play between the worm shaft 11 and the worm wheel 10, the screws 18 can be released and the play adjustment carried out again by means of the eccentric sleeve 6.

Other adjustment possibilities of the partial housing 4 in relation to the gearbox housing 3 are also conceivable, such as, for example, a parallel guidance in the direction of the flange 5 in FIG. 3 from top to bottom.

Common to all the embodiments is the fact that the spring damping and the compensation for the angle difference between the two axes of rotation 21 and 24 and a possible axial offset in the radial direction take place in a structural element, namely the flexible clutch 13. This makes the entire arrangement particularly compact and allows for an economical design, since the number of parts is reduced. The possibility of adjustment by relative displacement of the partial housing 4 and of the gearbox housing 3 allows for subsequent adjustment in the event of repair.

1.-7. (canceled)

8. A power assisted steering system comprising:
a motor including a motor shaft;
a worm shaft;
a clutch coupling the motor shaft to the worm shaft;
a worm wheel engaging the worm shaft; and
a gearbox housing enclosing the worm shaft and worm wheel, wherein a distal end of the worm shaft is mounted in a bearing, and a proximal end of the worm shaft is mounted to the clutch.

9. The power assisted steering system of claim 1, further comprising a partial housing coupled to the gearbox and enclosing the motor, wherein both ends of the motor shaft are mounted in the partial housing motor bearings, the partial housing is displaceable with respect to the gearbox housing, and the motor is locationally adjustable with the partial housing in a radial direction defined by an axis of rotation of the motor shaft.

10. The power assisted steering system of claim 9, wherein the partial housing is mounted to the gearbox housing in a rotatable seat, which is eccentric with respect to the motor shaft.

11. The power assisted steering system of claim 10, wherein the seat interacts with an eccentric sleeve adapted to be rotated from an exterior of the partial housing, and the partial housing is mounted to the gearbox housing so as to be torsionally resistant but radially displaceable.

12. The power assisted steering system of claim 9, wherein the partial housing is radially displaceable by less than 1 mm.

13. The power assisted steering system of claim 1, wherein the clutch comprises a torsionally stiff flexible clutch.

14. The power assisted steering system of claim 1, wherein the clutch comprises an elastic flexible clutch.

15. The power assisted steering system of claim 14, wherein the elastic flexible clutch comprises a jaw clutch having a plurality of claws and a pressure-elastic elastomer located between the claws.

16. A power assisted steering system comprising:
a motor including a motor shaft having an axis of rotation;
a worm shaft;
a clutch coupling the motor shaft to the worm shaft;
a worm wheel engaging the worm shaft,
a gearbox housing enclosing the worm shaft and worm wheel, wherein a distal end of the worm shaft is mounted in a bearing, and a proximal end of the worm shaft is mounted to the clutch; and
a partial housing coupled to the gearbox and enclosing the motor, wherein both ends of the motor shaft are mounted in the partial housing motor bearings, the partial housing is displaceable with respect to the gearbox housing, and the motor is locationally adjustable with the partial housing in a radial direction defined by the axis of rotation.

17. The power assisted steering system of claim 16, wherein the partial housing is mounted to the gearbox housing in a rotatable seat, which is eccentric with respect to the motor shaft.

18. The power assisted steering system of claim 17, wherein the seat interacts with an eccentric sleeve adapted to be rotated from an exterior of the partial housing, and the partial housing is mounted to the gearbox housing so as to be torsionally resistant but radially displaceable.

19. The power assisted steering system of claim 16, wherein the partial housing is radially displaceable by less than 1 mm.

20. The power assisted steering system of claim 16, wherein the clutch comprises a torsionally stiff flexible clutch.

21. The power assisted steering system of claim 16, wherein the clutch comprises an elastic flexible clutch.

22. The power assisted steering system of claim 21, wherein the elastic flexible clutch comprises a jaw clutch having a plurality of claws and a pressure-elastic elastomer located between the claws.
